(19) United States
(12) Patent Application Publication
(10) Pub. No.: US 2020/0159546 A1
(43) Pub. Date: May 21, 2020

(54) INTERFACE SWITCHING METHOD AND APPARATUS

(71) Applicant: Alibaba Group Holding Limited, Grand Cayman (KY)

(72) Inventors: Kai ZHOU, Hangzhou (CN); Taiju Liu, Hangzhou (CN); Zengchan Liu, Hangzhou (CN)

(21) Appl. No.: 16/773,514

(22) Filed: Jan. 27, 2020

Related U.S. Application Data
(63) Continuation of application No. PCT/CN2018/096772, filed on Jul. 24, 2018.

(30) Foreign Application Priority Data
Jul. 28, 2017 (CN) 201710632371.5

(51) Int. Cl. G06F 9/451; H04L 12/58

(52) U.S. Cl. CPC G06F 9/451; H04L 51/04

(57) ABSTRACT

A method including receiving a quick switching request for a second application function initiated by a first application function in an application program; recording snapshot data of an interface relating to the first application function; displaying a switching portal on an interface relating to the second application function, the switching portal being used for quickly switching to the interface relating to the first application function; and configuring the interface relating to the first application function according to the snapshot data when returning to the interface relating to the first application function through the switching portal.

### CROSS REFERENCE TO RELATED PATENT APPLICATIONS

This application claims priority to and is a continuation of PCT Patent Application No. PCT/CN2018/096772, filed on 24 Jul. 2018 and entitled “INTERFACE SWITCHING METHOD AND APPARATUS,” which claims priority to Chinese Patent Application No. 201710632371.5, filed on 28 Jul. 2017 and entitled “INTERFACE SWITCHING METHOD AND APPARATUS,” which are incorporated herein by reference in their entirety.

### TECHNICAL FIELD

One or more example embodiments of the present disclosure relate to the field of terminal technologies, and, more particularly, to interface switching methods and apparatuses.

### BACKGROUND

In conventional techniques, mobile group office platforms are more and more widely used in office processes of enterprises, educational institutions, government agencies and other organizations. A mobile group office platform may provide a variety of application functions, such as communication functions, approval functions, attendance functions, etc. In addition to the original application functions supported by the mobile group office platform, users may add more additional application functions in the form of mini programs. This not only improves the efficiency of communication between users and reducing the communication costs, but also helping to effectively improve the users' event handling efficiency and office efficiency.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

One or more example embodiments of the present disclosure provide interface switching methods and apparatuses.

In order to achieve the above objectives, one or more example embodiments of the present disclosure provide technical solutions as follows.

According to a one or more example embodiments of the present disclosure, an interface switching method is provided, comprising:

receiving a quick switching request for a second application function initiated by a first application function in an application program;

recording snapshot data of an interface relating to the first application function;

displaying a switching portal on an interface relating to the second application function, the switching portal being used for quickly switching to the interface relating to the first application function; and configuring the interface relating to the first application function according to the snapshot data when returning to the interface relating to the first application function through the switching portal.

According to one or more example embodiments of the present disclosure, an interface switching method is provided, comprising:

recording snapshot data of an interface relating to a first application function in an application program; and

configuring the interface relating to the first application function according to the snapshot data when leaving and then returning to the interface relating to the first application function.

According to one or more example embodiments of the present disclosure, an interface switching apparatus, is provided comprising:

a receiving unit for receiving a quick switching request for a second application function initiated by a first application function in an application program;

a first recording unit for recording snapshot data of an interface relating to the first application function;

a display unit for displaying a switching portal on an interface relating to the second application function, the switching portal being used for quickly switching to the interface relating to the first application function; and a first configuration unit for configuring the interface relating to the first application function according to the snapshot data when returning to the interface relating to the first application function through the switching portal.

According to one or more example embodiments of the present disclosure, an interface switching apparatus is provided, comprising:

a second recording unit for recording snapshot data of an interface relating to a first application function in an application program; and

a second configuration unit for configuring the interface relating to the first application function according to the snapshot data when leaving and then returning to the interface relating to the first application function.

As shown from the above technical solution, according to one or more example embodiments of the present disclosure, by displaying a switching portal, a user is enabled to quickly return to the first application function through the switching portal after jumping from the first application function to the second application function, thus contributing to simplifying the user's operation and improving the user's operation efficiency.

### BRIEF DESCRIPTION OF THE DRAWINGS

FIG. 1 is a flowchart of an interface switching method provided by an example embodiment.

FIG. 2 is a flowchart of another interface switching method provided by an example embodiment.

FIG. 3 is a flowchart for quickly realizing interface switching provided by an example embodiment.

FIG. 4 is a schematic diagram of a home page interface of a mini program provided by an example embodiment.

FIG. 5 is a schematic diagram of a function window called out in a mini program according to an example embodiment.

FIG. 6 is a schematic diagram of a new task interface of a mini program provided by an example embodiment.

FIG. 7 is a schematic diagram of another function window called out in a mini program provided by an example embodiment.

FIGS. 8A-8D are schematic diagrams of an instant messaging list interface provided by an example embodiment.

FIG. 9 is a schematic diagram of yet another function window called out in a mini program provided by an example embodiment.

FIG. 10 is a schematic structural diagram of an electronic device provided by an example embodiment.

FIG. 11 is a block diagram of an interface switching apparatus provided by an example embodiment.

FIG. 12 is a block diagram of another interface switching apparatus provided by an example embodiment.

### DETAILED DESCRIPTION

Example embodiments will be described in detail herein, examples of which are shown in the accompanying drawings. When the following description refers to the figures, unless otherwise indicated, the same numbers in different figures indicate the same or similar elements. The implementations described in the following example embodiments do not represent all implementations consistent with one or more example embodiments of the present disclosure. Rather, they are merely examples of apparatuses and methods consistent with some aspects of one or more example embodiments of the present disclosure as detailed in the appended claims.

According to one or more example embodiments of the present disclosure, by displaying a switching portal, a user is enabled to quickly return to the first application function through the switching portal after jumping from the first application function to the second application function, thus contributing to simplifying the user's operation and improving the user's operation efficiency.

In an example embodiment, the present disclosure may be applied to a mobile group office platform. The mobile group office platform may not only realize the communication function, but also serve as a function platform integrating many other functions, such as the processing of internal group events such as approval events (such as leave, application for office goods and financial affairs), attendance events, task events and log events, and the processing of external group events such as ordering meals and purchasing. The one or more example embodiments of the present disclosure are not limited thereto.

More specifically, the mobile group office platform may be based on an instant messaging application in conventional techniques, such as Enterprise Instant Messaging (EIM) applications, for example, Skype For Business Microsoft Teams®, Yammer®, Workplace®, Slack®, WeChat Work®, FXiaoKe®, QiyeFeixin® and QiyeYixin®. Of course, the instant messaging function is only one of the communication functions supported by the mobile group office platform, and the mobile group office platform may also realize more other functions such as the above mentioned, which will not be repeated here.

For example, by running a client terminal of a mobile group office platform on an electronic device, the client terminal may realize quick interface switching between a plurality of application functions in the client terminal based on the example embodiment of the present disclosure, wherein the application program of the client terminal of the mobile group office platform may be installed on the electronic device in advance, so that the client terminal may be started and run on the electronic device; and of course, when using an online “client terminal” such as HTML5 technology, the client terminal may be obtained and run without installing a corresponding application program on the electronic device. The electronic device may include mobile phones, personal computers (PCs), tablet devices, laptops, personal digital assistants (PDAs), wearable devices (such as smart glasses and smart watches), etc. The one or more example embodiments of the present disclosure are not limited thereto.

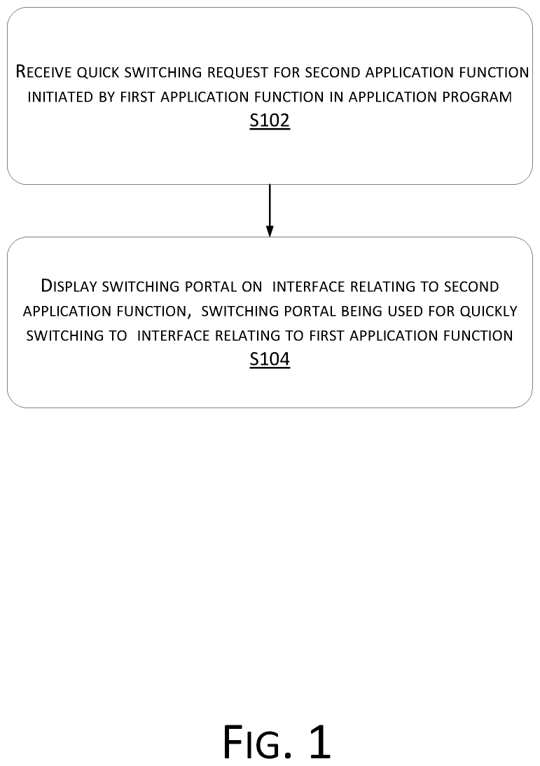

FIG. 1 is a flowchart of an interface switching method provided by an example embodiment. As shown in FIG. 1, the method may comprise:

Step 102, receiving a quick switching request for a second application function initiated by a first application function in an application program; and

Step 104, displaying a switching portal on an interface relating to the second application function, the switching portal being used for quickly switching to the interface relating to the first application function.

In an example embodiment, the present disclosure may be applied to any application program comprising a plurality of application functions, and the present disclosure is not limited thereto.

In one example embodiment, the application program in this example embodiment may comprise a client terminal of the above-mentioned mobile group office platform, so as to realize quick interface switching operation between a plurality of application functions included in the client terminal.

In one example embodiment, the first application function and the second application function may be native application functions of the application program. Take an enterprise instant messaging application as an example, the first application function may include enterprise office management functions, such as approval functions and attendance functions, and the second application function may include instant messaging application functions, etc.

In one example embodiment, the first application function and the second application function may be mini programs in the application program. The mini programs (or “applets”) are different from the native application functions of the application program and may be added selectively by users according to actual needs after running the application program. In one example embodiment, the running of a mini program depends on the application program and the mini program cannot be run independently.

In one example embodiment, the first application function may be a mini program in the application program, and the second application function may be a native application function in the application program. For example, assuming that the application program is a messaging application, the second application function may include an instant messaging function of the messaging application, and the interface relating to the second application function may include a message list interface of the instant messaging function. In another example embodiment, the first application function may be a native application function in the application program, and the second application function may be a mini program in the application program.

In one example embodiment, the switching portal may be displayed in the top area of the interface relating to the second application function, so as to help the user to quickly distinguish and trigger the switching portal. In other example embodiments, the switching portal may be displayed at other positions of the interface relating to the second application function, and the present disclosure is not limited thereto.

In one example embodiment, the switching portal may be displayed in a floating manner on the interface relating to the second application function, that is, the switching portal is displayed “above” other display contents on the interface relating to the second application function, so that the display position of the switching portal does not change with the scrolling of the interface relating to the second application function, ensuring that the switching portal may still be triggered quickly and accurately by a user even if the interface relating to the second application function is scrolled, so as to realize quick interface switching operation.

In one example embodiment, snapshot data of an interface relating to the first application function may be recorded, and the interface relating to the first application function may be configured according to the snapshot data when returning to the interface relating to the first application function through the switching portal, so that even if a user switches from the first application function to the second application function, it may be ensured that data of the interface relating to the first application function will not be lost and thus the user does not need to input or fill in information again when returning to the first application function from the second application function.

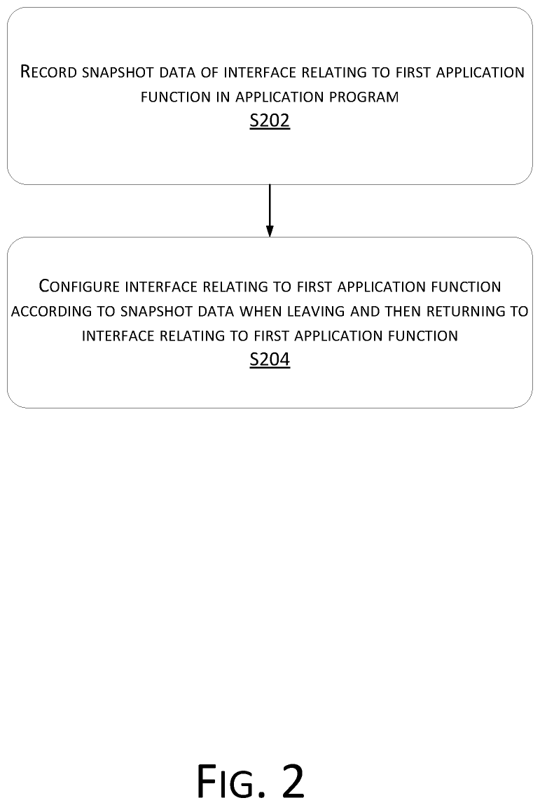

FIG. 2 is a flowchart of another interface switching method provided by an example embodiment. As shown in FIG. 2, the method may comprise the following steps:

Step 202: recording snapshot data of an interface relating to a first application function in an application program.

In one example embodiment, the snapshot data may be recorded when leaving the interface relating to the first application function is detected. In other example embodiments, the snapshot data may be recorded in other ways, such as automatically recording snapshot data periodically. The present disclosure is not limited thereto.

Step 204: configuring the interface relating to the first application function according to the snapshot data when leaving and then returning to the interface relating to the first application function.

In one example embodiment, by recording the snapshot data and configuring the interface relating to the first application function according to the snapshot data, it may be ensured that data of the interface relating to the first application function will not be lost and thus the user does not need to input or fill in information again when leaving and then returning to the first application function again.

In one example embodiment, the interface relating to the first application function may be configured according to snapshot data when switching from the interface relating to the first application function to an interface relating to a second application function in the application program and then returning to the interface relating to the first application function from the interface relating to the second application function.

In an example embodiment, the present disclosure may be applied to any application program comprising a plurality of application functions, and the present disclosure is not limited thereto.

In one example embodiment, the application program in this example embodiment may comprise a client terminal of the above-mentioned mobile group office platform, so as to realize quick interface switching operation between a plurality of application functions included in the client terminal.

In one example embodiment, the first application function and the second application function may be native application functions of the application program. Take an enterprise instant messaging application as an example, the first application function may include enterprise office management functions, such as approval functions and attendance functions, and the second application function may include instant messaging application functions, etc.

In one example embodiment, the first application function and the second application function may be mini programs in the application program, which are different from native application functions of the application program and may be selectively added by a user according to actual needs after running the application program. In one example embodiment, the running of a mini program depends on the application program and the mini program cannot be run independently.

In one example embodiment, the first application function may be a mini program in the application program, and the second application function may be a native application function in the application program. For example, assuming that the application program is a messaging application, the second application function may include an instant messaging function of the messaging application, and the interface relating to the second application function may include a message list interface of the instant messaging function. In another example embodiment, the first application function may be a native application function in the application program, and the second application function may be a mini program in the application program.

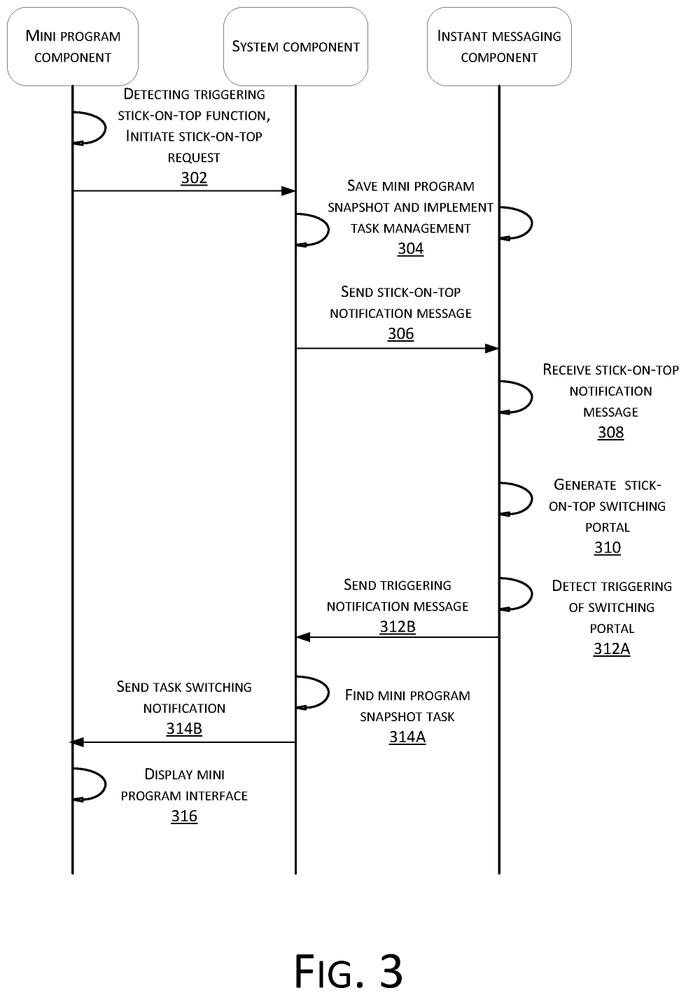

In order to facilitate understanding, the following describes the technical solution of one or more example embodiments of the present disclosure by taking the EIM application as an example. FIG. 3 is a flowchart for quickly realizing interface switching provided by an example embodiment. As shown in FIG. 3, it is assumed that the client terminal of the EIM application may comprise: system components for supporting normal operation of programs, instant messaging components for realizing instant messaging functions, and mini program components for realizing certain application functions, wherein the system components and the instant messaging components may be native components of the client terminal, while the mini program components may be non-native components acquired through the client terminal of the EIM application and used to realize the application functions of corresponding mini programs.

As shown in FIG. 3, quick interface switching may be realized between the functional interface of the mini program and the functional interface of the instant messaging component through the following steps:

In step 302, when detecting that a stick-on-top function is triggered for the mini program component, the mini program component initiates a stick-on-top request to the system component.

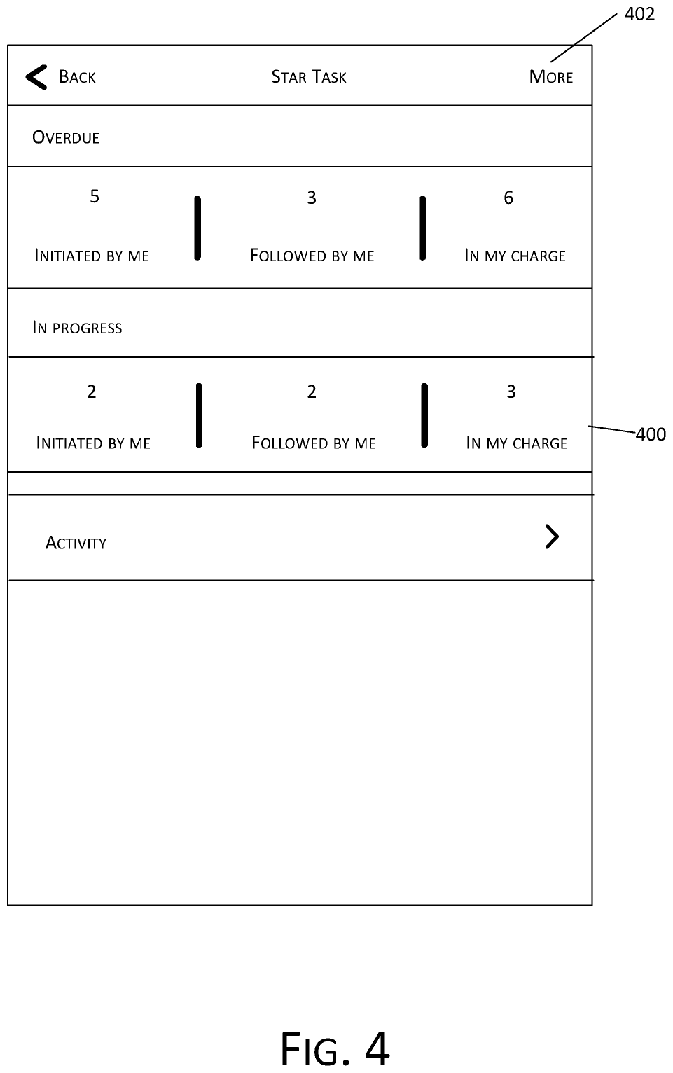

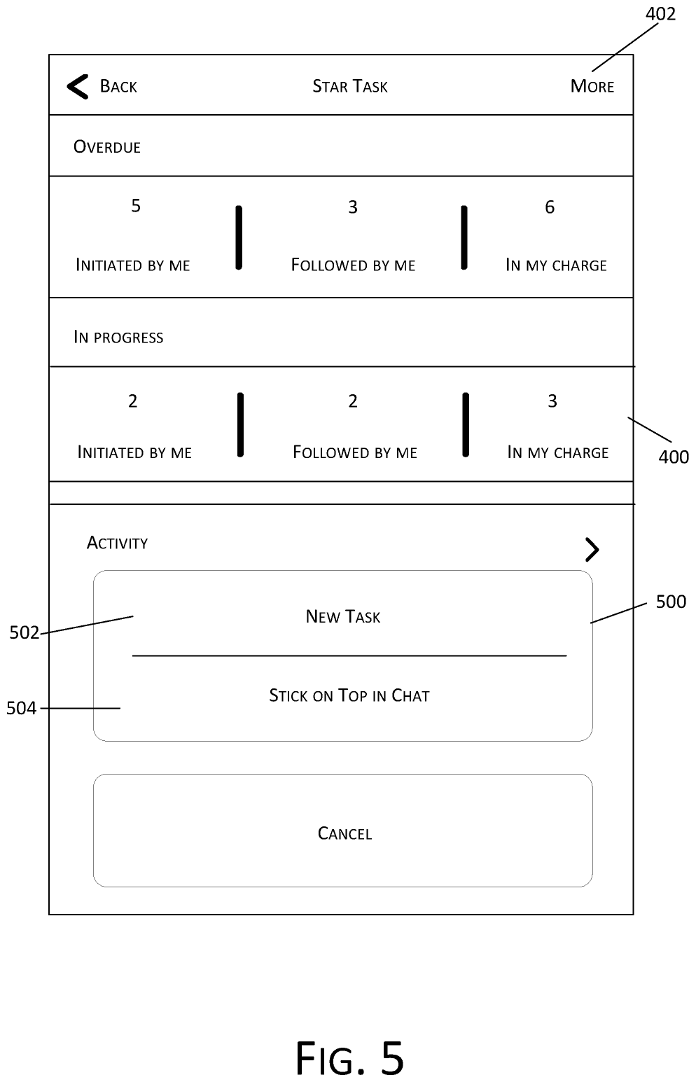

In one example embodiment, FIG. 4 is a schematic diagram of a home page interface of a mini program provided by an example embodiment. As shown in FIG. 4, it is assumed that the above-mentioned mini program component is a mini program named “Star Task,” which is used to realize the task management function in the EIM application. In the mini program home page 400 shown in FIG. 4, a function option 402 may be provided. The function window 500 shown in FIG. 5 may be called out when a user's triggering operation for the function option 402 is detected, taking such a case as an example where the triggering operation may comprise clicking on the function option 402.

FIG. 5 is a schematic diagram of a function window called out in a mini program according to an example embodiment. As shown in FIG. 5, the function window 500 may comprise several options for realizing corresponding preset functions. For example, the option 502 is used for realizing the application function of “New Task” in the mini program “Star Task,” while the option 504 is used for realizing the application function of quick interface switching in this example embodiment. When the triggering operation of the user for the option 504 is detected, such as clicking on the option 504, it may be determined that the triggering of stick-on-top function for the mini program component is detected

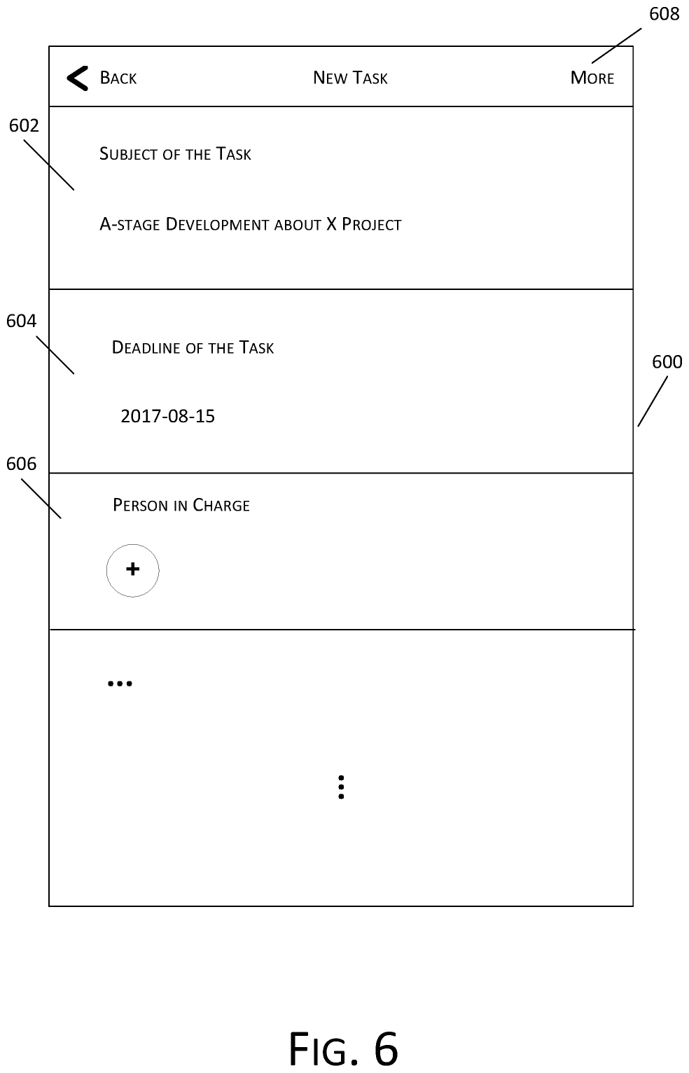

FIG. 6 is a schematic diagram of a new task interface of a mini program provided by an example embodiment. When the triggering operation for the option 502 shown in FIG. 5 is detected, the user may go to the new task interface 600 shown in FIG. 6. As shown in FIG. 6, the new task interface 600 may comprise corresponding fill-in items 602, 604, 606, etc., such as “task theme,” “task duration,” “person in charge,” etc., which need to be manually configured by the user according to the actual situation.

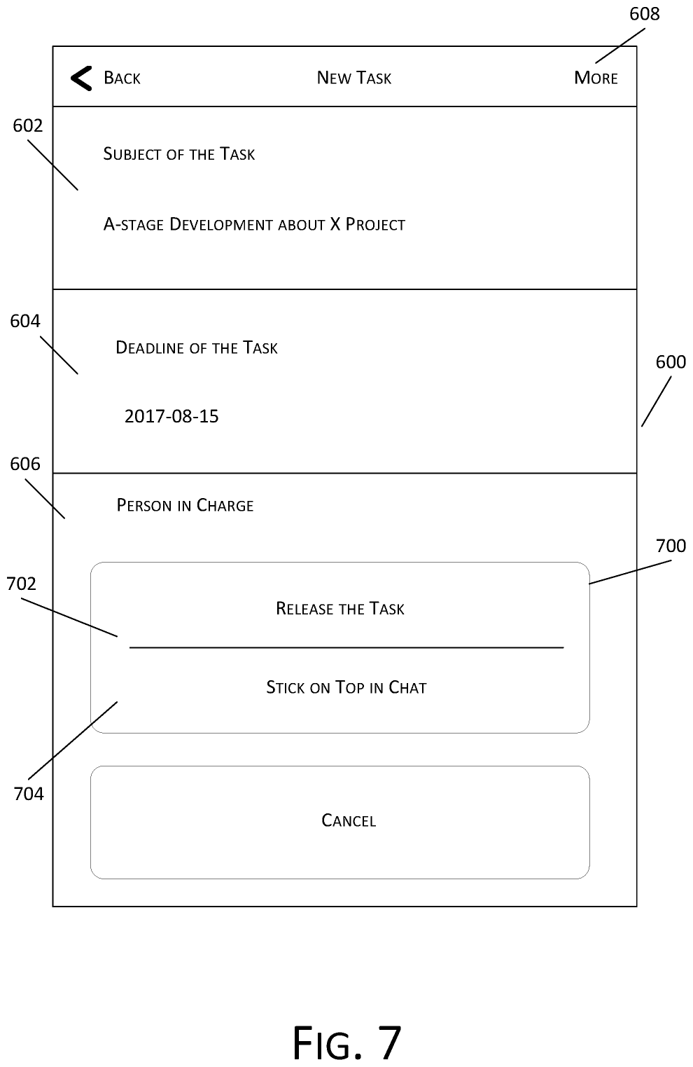

It is assumed that the user has completed the configuration of the fill-in items 602 and 604, respectively, but has not completed the configuration of the fill-in item 606, at which moment, however, the user needs to temporarily jump to the function interface of the instant messaging component due to receiving a new chat message or other reasons. Then, the user may call out the function window 700 shown in FIG. 7 by triggering the function option 608 included in the new task interface 600.

FIG. 7 is a schematic diagram of another function window called out in a mini program provided by an example embodiment. As shown in FIG. 7, similar to the function window 500 shown in FIG. 5, the function window 700 may include several options for implementing corresponding preset functions. For example, the option 702 is used for releasing a task newly created by the user, and the option 704 is used for implementing the application function of quick interface switching in this example embodiment. Therefore, when the triggering operation of the user for the option 704 is detected, such as clicking on the option 704, it may be determined that the triggering of stick-on-top function for the mini program component is detected.

In step 304, the system component saves a mini program snapshot and implements task management.

In one example embodiment, since the user calls out the function window 700 in the new task interface 600 and further triggers the option 704, the system component may acquire the mini program snapshot corresponding to the new task interface 600 and implement the corresponding task management. The mini program snapshot refers to a snapshot for the new task interface 600, which is used to obtain the configuration data that the user has completed for the new task interface 600, so as to realize the restoration display of the new task interface 600 in a subsequent step 316, which will be described in detail hereinafter in connection with the subsequent step 316.

In one example embodiment, by implementing task management, a mini program snapshot task for the mini program snapshot may be created, so that in the subsequent step 316, the new task interface 600 may be restored and displayed according to the mini program snapshot task.

In step 306, the system component sends a stick-on-top notification message to the instant messaging component.

In step 308, the instant messaging component receives the stick-on-top notification message.

In step 310, the instant messaging component generates a stick-on-top switching portal according to the stick-on-top notification message.

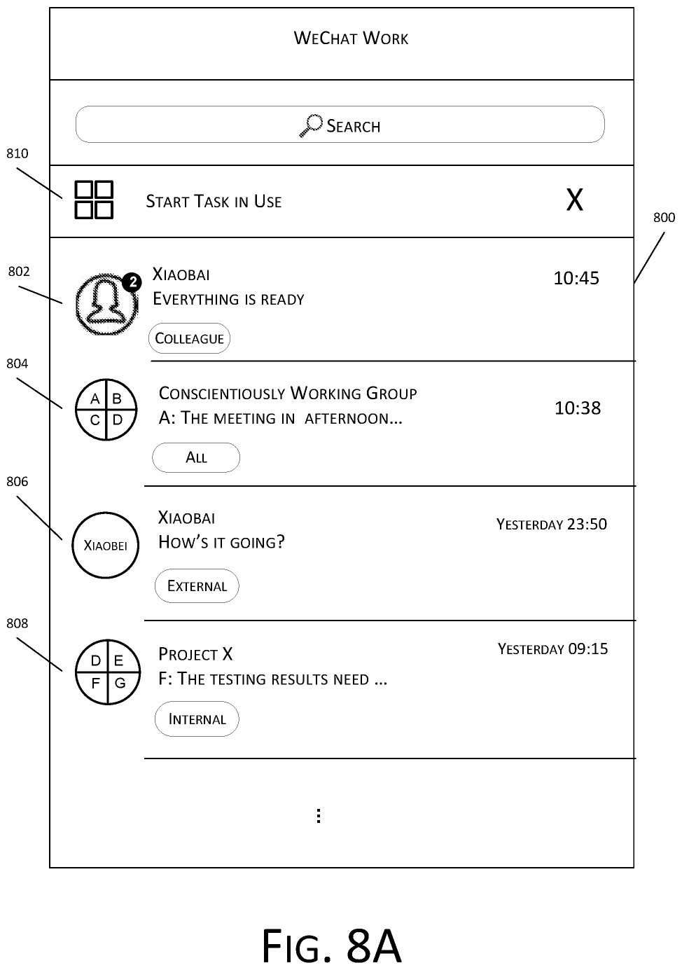

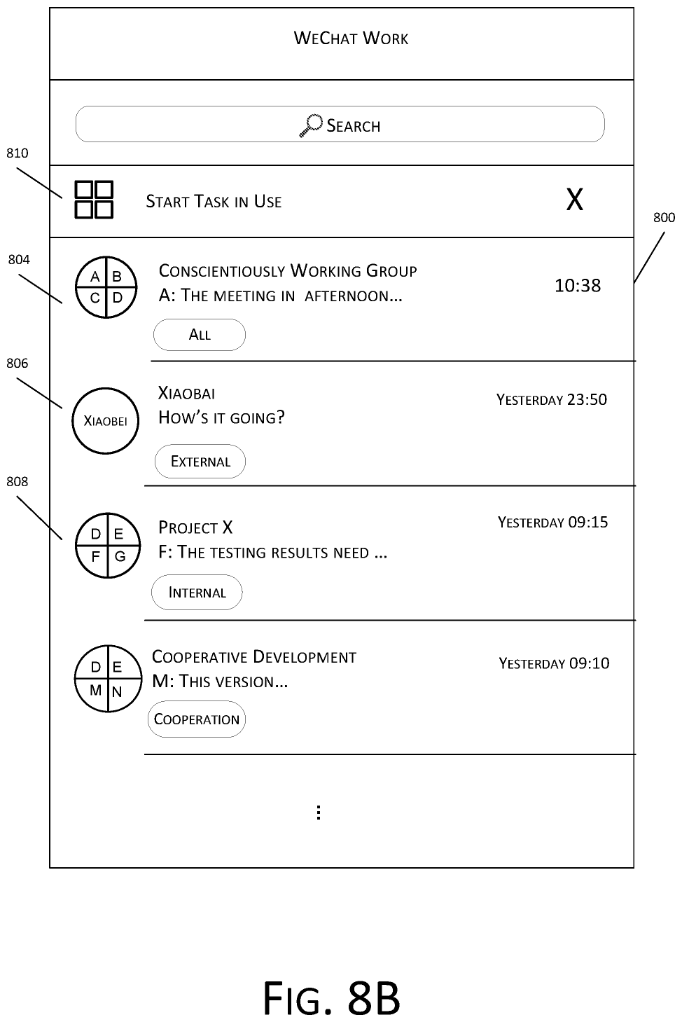

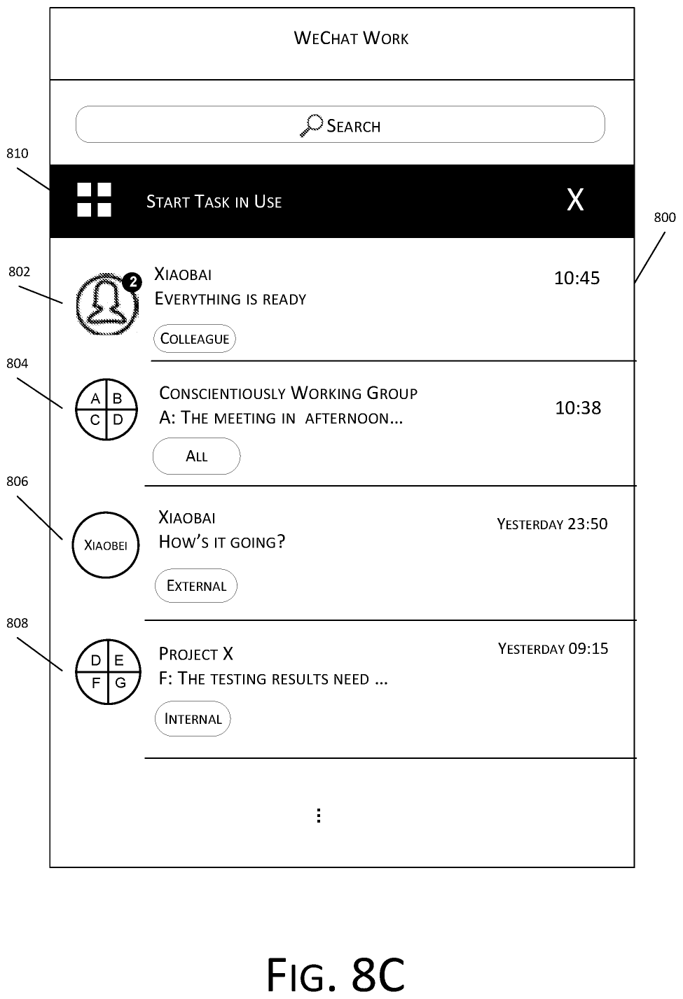

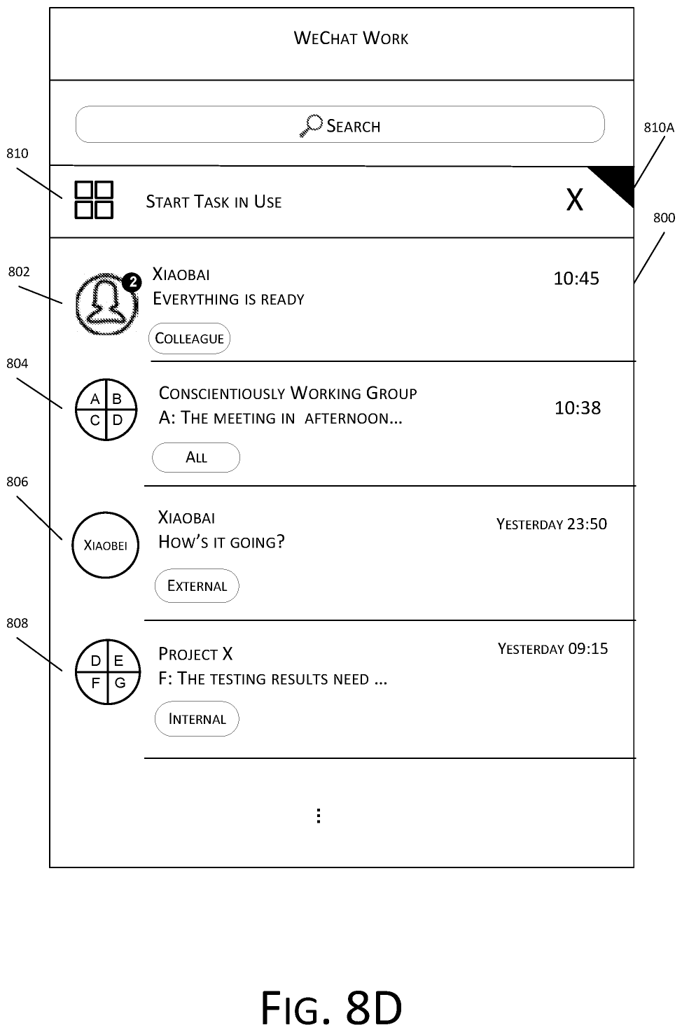

In one example embodiment, FIGS. 8A-8D are schematic diagrams of an instant messaging list interface provided by an example embodiment. As shown in FIG. 8A, the instant messaging list interface 800 provided by the instant messaging component is used to arrange and display the interface portals corresponding to the instant messaging sessions in which the local user participated. For example, the interface portal 802 is used to enter the messaging session interface of the one-on-one chat messaging session between the local user and the user “Xiaobai,” the interface portal 804 is used to enter the messaging session interface of the group “Conscientiously Working Group” in which the local user joined, the interface portal 806 is used to enter the messaging session interface of the one-on-one chat messaging session between the local user and the user “Xiaobei,” the interface portal 808 is used to enter the messaging session interface of the group “X Project” in which the local user joined, etc.

As shown in FIG. 8A, at the top of the interface portals displayed in the instant messaging list interface 800, a switching portal 810 corresponding to the mini program “Star Task” may be displayed, i.e., the switching portal 810 is displayed on top of the instant messaging list interface 800, so that the user may quickly locate, find and trigger the switching portal 810.

In one example embodiment, the switching portal 810 may be displayed in a floating manner on the instant messaging list interface 800, so that even if the user scrolls on the instant messaging list interface 800 shown in FIG. 8A to change it to the state shown in FIG. 8B, the position of the switching portal 810 on the display screen of the electronic device remains unchanged, and the switching portal 810 will not move out of the display screen due to scrolling, so as to ensure that the user may easily trigger the switching portal 810 at any time.

In the example embodiments of the present disclosure, in addition to the example embodiment shown in FIGS. 8A and 8B, where the switching portal 810 and other display contents in the instant messaging list interface 800 are displayed in a differentiated manner so as to help the user to quickly locate, find and trigger the switching portal 810, this may be implemented in many other ways, and the present disclosure is not limited thereto.

For example, in the example embodiment shown in FIG. 8C, a background color, text color, etc. different from the interface portals 802-808 may be used for the switching portal 810, and in the example embodiment shown in FIG. 8D, a feature icon 810A may be displayed in the upper right corner (or at any other optional position) of the switching portal 810, while the corresponding positions of the interface portals 802-808 may be displayed in other ways or without any content. Therefore, according to the above-mentioned example embodiments of FIGS. 8C, 8D, etc., the user may quickly locate, find, and trigger the switching portal 810, and realize quick switching between the instant messaging list interface 800 and the new task interface 600 (or other interfaces corresponding to the switching portal 810).

In one example embodiment, after triggering the option 704 shown in FIG. 7, the user may manually exit the mini program “Star Task” and open the instant messaging list interface 800 shown in FIG. 8A, and the instant messaging list interface 800 will show the switching portal 810.

In one example embodiment, after the user triggers the option 704 shown in FIG. 7, the EIM application may automatically jump to the instant messaging list interface 800 shown in FIG. 8A without requiring the user to manually perform the interface switching operation, so as to realize more efficient interface switching.

In step 312a, when the instant messaging component detects that the switching portal of displayed on top is triggered, it sends a triggering notification message to the system component in step 312b.

In step 314a, the system component finds the mini program snapshot task generated in step 304 and sends a task switching notification to the mini program component in step 314b.

In step 316, the mini program component displays the mini program interface before switching.

In one example embodiment, when the user calls out the function window 700 shown in FIG. 7 and triggers the option 704 shown in FIG. 6 in the new task interface 600 shown in FIG. 6, so that the EIM application displays the switching portal 810 in the instant messaging list interface 800 shown in FIGS. 8A-8D, the EIM application may automatically jump back to the new task interface 600 based on the user's triggering operation for the switching portal 810, so that the user may resume the operation for the new task interface 600.

In one example embodiment, since the system component saves the mini program snapshot of the new task interface 600, when returning to the new task interface 600 quickly through the switching portal 810, the EIM application may automatically configure the new task interface 600 according to the mini program snapshot, such as automatically filling in the fill-in items 602, 604, etc. in the new task interface 600 to completely restore to the state shown in FIG. 6, thus avoiding data loss caused by interface switching between the mini program component and the instant messaging component, thus eliminating the need for the user to re-fill in the information.

In one example embodiment, in addition to the new task interface 600, other function interfaces of mini programs may also realize quick interface switching operation through the above process. For example, as shown in FIG. 5, when it is detected that the option 504 in the function window 500 is triggered by the user, the EIM application may display the switching portal 810 corresponding to the mini program home page 400 in the instant messaging list interface 800 shown in FIGS. 8A-8D, so that the user may quickly return to the mini program home page 400 through the switching portal 810. When the mini program home page 400 does not contain such editable items as the fill-in option 602 in the new task interface 600 or other similar items, the system component may not need to save the corresponding mini program snapshot in step 304, but the above-mentioned quick interface switching function may still be realized.

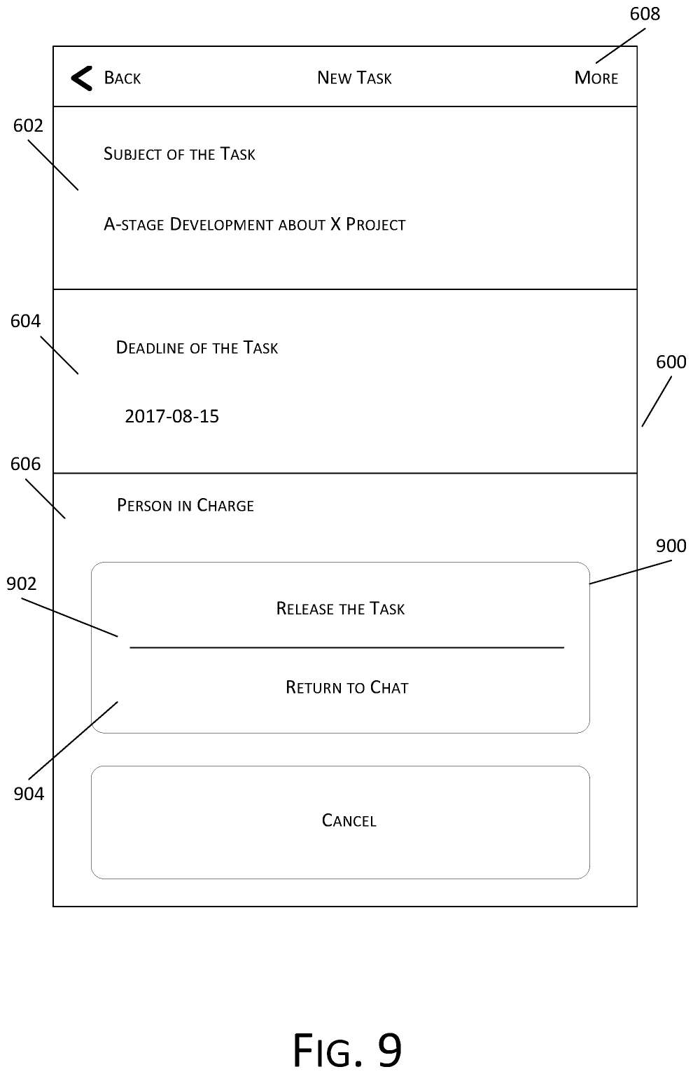

In one example embodiment, taking the new task interface 600 as an example, when the user calls out the function window 700 shown in FIG. 7, if the call-out operation is the first operation after the user enters the new task interface 600, the option 704 in the function window 700 may be displayed as “stick on top in chat” or other contents. However, when the user continuously switches between the new task interface 600 and the instant messaging list interface 800, the same processing solution or other processing solutions may be used for non-first operations. For example, FIG. 9 is a schematic diagram of yet another function window called out in a mini program provided by an example embodiment. As shown in FIG. 9, when a user calls out a function window 900 through a new task interface 600 for the first time, the function window 900 displays an option 904 for realizing the application function of the quick interface switching of this example embodiment, and the option 904 may be displayed as “return to chat” or other content to distinguish from the above-mentioned first operation. The situation is similar when the user performs operations through the mini program homepage 400 or other mini program interfaces, and will not be repeated here.

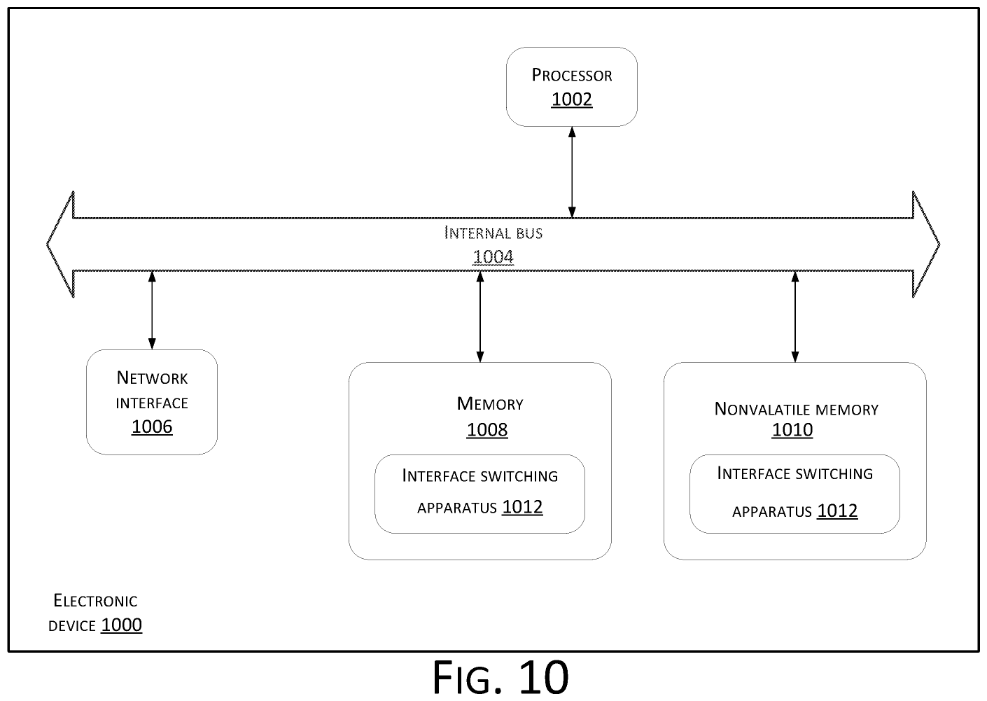

FIG. 10 is a schematic structural diagram of an electronic device 1000 according to an example embodiment. Referring to FIG. 10, at the hardware level, the electronic device 1000 comprises a processor 1002, an internal bus 1004, a network interface 1006, a memory 1008, and a nonvolatile memory 1010, and of course may also comprise other hardware required for services. The processor 1002 reads the corresponding computer program from the non-volatile memory 1010 into the memory 1008 and then runs the program to form an interface switching apparatus 1012 at the logical level. Of course, in addition to the software implementation, the one or more example embodiments of the present disclosure do not exclude other implementations, such as logic means or a combination of software and hardware, that is to say, the executing body of the following processing flow is not limited to logic units, but may also be hardware or logic means. Both the memory 1008 and the nonvolatile memory 1010 are examples of computer readable media.

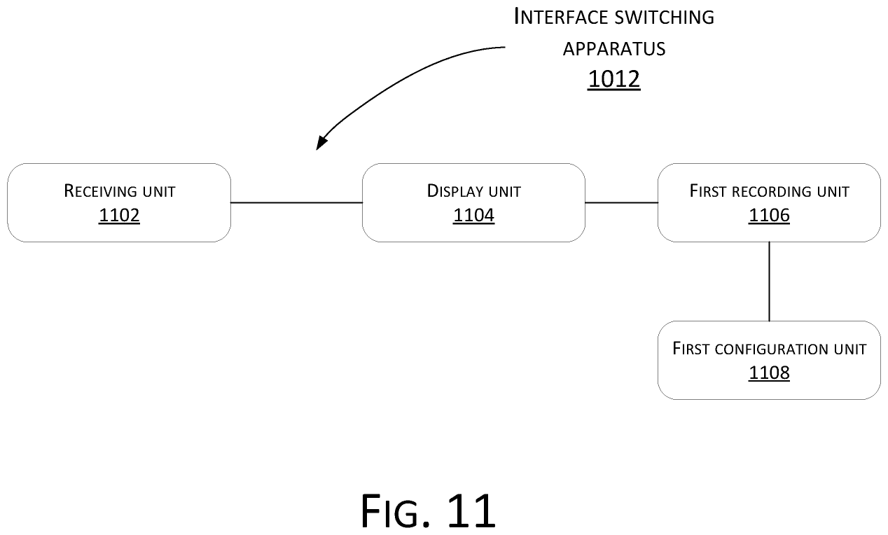

Referring to FIG. 11, in a software implementation, the interface switching apparatus 1012 may comprise:

a receiving unit 1102 for receiving a quick switching request for a second application function initiated by a first application function in an application program; and

a display unit 1104 for displaying a switching portal on an interface relating to the second application function, the switching portal being used for quickly switching to the interface relating to the first application function.

For example, the first application function comprises a mini program in the application program, and the second application function comprises a native application function in the application program.

For example, the application program comprises a communication application, the second application function comprises an instant messaging function of the communication application, and the interface relating to the second application function comprises a message list interface of the instant messaging function.

For example, the display unit 1104 is specifically used for:

displaying the switching portal in a top area of the interface relating to the second application function.

For example, the display unit 1104 is specifically used for:

displaying the switching portal in a floating manner on the interface relating to the second application function.

For example, the interface switching apparatus 1012 further comprises:

a first recording unit 1106 for recording snapshot data of an interface relating to the first application function; and

a first configuration unit 1108 for configuring the interface relating to the first application function according to the snapshot data when returning to the interface relating to the first application function through the switching portal.

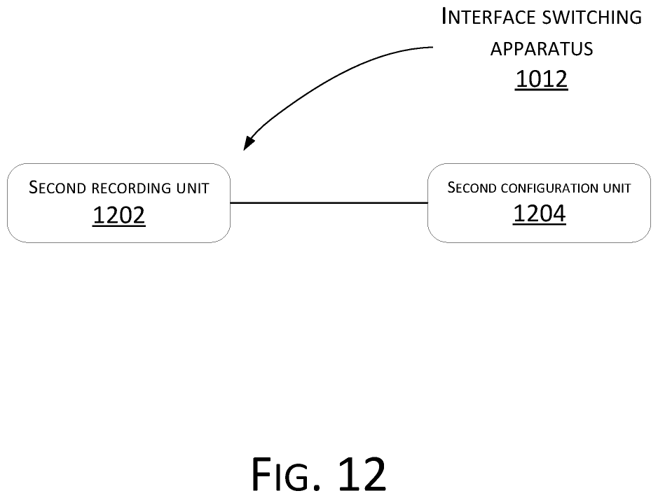

Referring to FIG. 12, in a software implementation, the interface switching apparatus may comprise:

a second recording unit 1202 for recording snapshot data of an interface relating to a first application function in an application program; and

a second configuration unit 1204 for configuring the interface relating to the first application function according to the snapshot data when leaving and then returning to the interface relating to the first application function.

For example, the second recording unit 1202 is specifically used for:

recording the snapshot data when leaving the interface relating to the first application function is detected.

For example, the leaving and then returning to the interface relating to the first application function comprises: switching from the interface relating to the first application function to an interface relating to a second application function in the application program, and returning to the interface relating to the first application function from the interface relating to the second application function.

For example, the first application function comprises a mini program in the application program, and the second application function comprises a native application function in the application program.

The systems, apparatus, modules or units illustrated in the above example embodiments may be implemented by computer chips or entities, or by products with certain functions. A typical implementation device is a computer, and the specific form of the computer may be a personal computer, a laptop computer, a cellular phone, a camera phone, a smart phone, a personal digital assistant, a media player, a navigation device, an email sending and receiving device, a game console, a tablet computer, a wearable device, or a combination of any of these devices.

In a typical configuration, a computer comprises one or more central processing units (CPUs), an input/output interface, a network interface, and memory.

The memory may include volatile memory, random access memory (RAM) and/or non-volatile memory in a computer readable medium, such as read-only memory (ROM) or flash random access memory (flash RAM). The memory is an example of a computer readable medium.

Computer readable media include permanent and non-permanent, removable and non-removable media. Information storage may be implemented by any method or technology. The information may be computer-readable instructions, data structures, modules of programs or other data. Examples of storage media for computers include, but are not limited to, phase-change random access memory (PRAM), static random access memory (SRAM), dynamic random access memory (DRAM), other types of random access memory (RAM), read-only memory (ROM), electrically erasable programmable read only memory (EEPROM), flash memory or other memory technologies, compact disc read-only memory (CD-ROM), digital versatile disc (DVD) or other optical storage, magnetic cassette tape, magnetic disk storage, quantum memory, graphene-based storage media or other magnetic storage devices or any other non-transmission media that may be used to store information that may be accessed by computing devices. As defined herein, the computer readable media do not include transitory computer readable media such as modulated data signals and carrier waves.

It should also be noted that the terms “comprise,” “include” or any other variation thereof are intended to cover a non-exclusive inclusion, such that a process, method, product, or device that comprises a list of elements comprises not only those listed elements, but also other elements not expressly listed or elements inherent to such a process, method, product or device. Without further restrictions, an element defined by the statement “comprising a/an . . . ” does not exclude the presence of another identical element in a process, method, product or device that comprises the element.

Specific example embodiments of the present disclosure have been described above. Other example embodiments are within the scope of the appended claims. In some cases, the actions or steps recited in the claims may be performed in a different order than in the example embodiments and the desired results may still be achieved. In addition, the processes depicted in the drawings do not necessarily require the specific sequence or consecutive sequence shown to achieve the desired results. In some example embodiments, multitasking and parallel processing are also possible or may be advantageous.

The terminology used in one or more example embodiments of the present disclosure is for the purpose of describing particular example embodiments only and is not intended to limit one or more example embodiments of the present disclosure. As used in one or more example embodiments of the present disclosure and the appended claims, the singular forms “a/an,” “said” and “the” are also intended to include the plural forms unless otherwise indicated clearly herein. It should also be understood that the term “and/or” as used herein refers to and comprises any or all possible combinations of one or more associated listed items.

It should be understood that although the terms “first,” “second,” “third,” etc. may be used to describe various information in one or more example embodiments of the present disclosure, the information should not be limited to these terms. These terms are only used to distinguish the same type of information from each other. For example, without departing from the scope of one or more example embodiments of the present disclosure, the first information may also be referred to as second information, and similarly, the second information may also be referred to as first information. Depending on the context, the word “if” as used herein may be interpreted as “while” or “when” or “in response to determining that.”

The above description only includes example embodiment of the present disclosure and is not intended to limit the one or more example embodiments of the present disclosure. Any modification, equivalent substitution, improvement, etc. made within the spirit and principles of the one or more example embodiments of the present disclosure shall be included within the scope of protection of the one or more example embodiments of the present disclosure.

The present disclosure may further be understood with clauses as follows.

Clause 1. An interface switching method, comprising:

receiving a quick switching request for a second application function initiated by a first application function in an application program;

recording snapshot data of an interface relating to the first application function;

displaying a switching portal on an interface relating to the second application function, the switching portal being used for quickly switching to the interface relating to the first application function; and

configuring the interface relating to the first application function according to the snapshot data when returning to the interface relating to the first application function through the switching portal.

Clause 2. The method of clause 1, wherein:

the first application function comprises a mini program in the application program; and

the second application function comprises a native application function in the application program.

Clause 3. The method of clause 2, wherein:

the application program comprises a communication application;

the second application function comprises an instant messaging function of the communication application; and

the interface relating to the second application function comprises a message list interface of the instant messaging function.

Clause 4. The method of clause 1, wherein the displaying the switching portal on the interface relating to the second application function comprises:

displaying the switching portal in a top area of the interface relating to the second application function.

Clause 5. The method of clause 1, wherein the displaying the switching portal on the interface relating to the second application function comprises:

displaying the switching portal in a floating manner on the interface relating to the second application function.

Clause 6. An interface switching method comprising:

recording snapshot data of an interface relating to a first application function in an application program; and

configuring the interface relating to the first application function according to the snapshot data when leaving and then returning to the interface relating to the first application function.

Clause 7. The method of clause 6, wherein the recording the snapshot data of the interface relating to the first application function in the application program comprises:

recording the snapshot data when leaving the interface relating to the first application function is detected.

Clause 8. The method of clause 6, wherein the leaving and then returning to the interface relating to the first application function comprises:

switching from the interface relating to the first application function to an interface relating to a second application function in the application program; and

returning to the interface relating to the first application function from the interface relating to the second application function.

Clause 9. The method of clause 8, wherein:

the first application function comprises a mini program in the application program; and

the second application function comprises a native application function in the application program.

Clause 10. An interface switching apparatus comprising:

a receiving unit for receiving a quick switching request for a second application function initiated by a first application function in an application program;

a first recording unit for recording snapshot data of an interface relating to the first application function;

a display unit for displaying a switching portal on an interface relating to the second application function, the switching portal being used for quickly switching to the interface relating to the first application function; and

a first configuration unit for configuring the interface relating to the first application function according to the snapshot data when returning to the interface relating to the first application function through the switching portal.

Clause 11. The apparatus of clause 10, wherein:

the first application function comprises a mini program in the application program; and

the second application function comprises a native application function in the application program.

Clause 12. The apparatus of clause 11, wherein:

the application program comprises a communication application;

the second application function comprises an instant messaging function of the communication application; and

the interface relating to the second application function comprises a message list interface of the instant messaging function.

Clause 13. The apparatus of clause 10, wherein the display unit is specifically used for:

displaying the switching portal in a top area of the interface relating to the second application function.

Clause 14. The apparatus of clause 10, wherein the display unit is specifically used for:

displaying the switching portal in a floating manner on the interface relating to the second application function.

Clause 15. An interface switching apparatus comprising:

a second recording unit for recording snapshot data of an interface relating to a first application function in an application program; and

a second configuration unit for configuring the interface relating to the first application function according to the snapshot data when leaving and then returning to the interface relating to the first application function.

Clause 16. The apparatus of clause 15, wherein the second recording unit is specifically used for:

recording the snapshot data when leaving the interface relating to the first application function is detected.

Clause 17. The apparatus of clause 15, wherein the leaving and then returning to the interface relating to the first application function comprises:

switching from the interface relating to the first application function to an interface relating to a second application function in the application program; and

returning to the interface relating to the first application function from the interface relating to the second application function.

Clause 18. The apparatus of clause 17, wherein:

the first application function comprises a mini program in the application program; and

the second application function comprises a native application function in the application program.

What is claimed is:

1. A method comprising:
receiving a switching request for a second application function initiated by a first application function in an application program;
recording snapshot data of an interface relating to the first application function;
displaying a switching portal on an interface relating to the second application function, the switching portal being used for switching to the interface relating to the first application function; and
configuring the interface relating to the first application function according to the snapshot data when returning to the interface relating to the first application function through the switching portal.

2. The method of claim 1, wherein the first application function comprises a mini program in the application program.

3. The method of claim 1, wherein the second application function comprises a native application function in the application program.

4. The method of claim 1, wherein the application program comprises a communication application.

5. The method of claim 4, wherein the second application function comprises an instant messaging function of the communication application.

6. The method of claim 5, wherein the interface relating to the second application function comprises a message list interface of the instant messaging function.

7. The method of claim 1, wherein the displaying the switching portal on the interface relating to the second application function comprises:
displaying the switching portal in a top area of the interface relating to the second application function.

8. The method of claim 1, wherein the displaying the switching portal on the interface relating to the second application function comprises:
displaying the switching portal in a floating manner on the interface relating to the second application function.

9. One or more computer readable media storing computer-readable instructions that, executable by one or more processors, cause the one or more processors to perform acts comprising:
recording snapshot data of an interface relating to a first application function in an application program; and
configuring the interface relating to the first application function according to the snapshot data when detecting leaving and then returning to the interface relating to the first application function.

10. The one or more computer readable media of claim 9, wherein the recording the snapshot data of the interface relating to the first application function in the application program comprises:
recording the snapshot data when leaving the interface relating to the first application function is detected.

11. The one or more computer readable media of claim 9, wherein the leaving and then returning to the interface relating to the first application function comprises:
switching from the interface relating to the first application function to an interface relating to a second application function in the application program; and
returning to the interface relating to the first application function from the interface relating to the second application function.

12. The one or more computer readable media of claim 9, wherein the first application function comprises a mini program in the application program.

13. The one or more computer readable media of claim 12, wherein the second application function comprises a native application function in the application program.

14. An electronic device comprising:
one or more processors; and
one or more computer readable media storing computer-readable instructions that, executable by the one or more processors, cause the one or more processors to perform acts comprising:
receiving a quick switching request for a second application function initiated by a first application function in an application program;
recording snapshot data of an interface relating to the first application function;
displaying a switching portal on an interface relating to the second application function, the switching portal being used for quickly switching to the interface relating to the first application function; and
configuring the interface relating to the first application function according to the snapshot data when returning to the interface relating to the first application function through the switching portal.

15. The electronic device of claim 14, wherein:
the first application function comprises a mini program in the application program; and
the second application function comprises a native application function in the application program.

16. The electronic device of claim 15, wherein the application program comprises a communication application.

17. The electronic device of claim 16, wherein the second application function comprises an instant messaging function of the communication application.

18. The electronic device of claim 17, wherein the interface relating to the second application function comprises a message list interface of the instant messaging function.

19. The electronic device of claim 14, wherein the displaying the switching portal on the interface relating to the second application function comprises:
displaying the switching portal in a top area of the interface relating to the second application function.

20. The electronic device of claim 14, wherein the displaying the switching portal on the interface relating to the second application function comprises:
displaying the switching portal in a floating manner on the interface relating to the second application function.
